(19) United States
(12) Patent Application Publication
(10) Pub. No.: US 2015/0331545 A1
(43) Pub. Date: Nov. 19, 2015

(54) LAMINATED OPTICAL ELEMENT FOR TOUCH-SENSING SYSTEMS

(71) Applicant: FLATFROG LABORATORIES AB, Lund (SE)

(72) Inventors: Ola WASSVIK, Brosarp (SE); Håkan BERGSTRÖM, Torna-Hallestad (SE); Thomas CRAVEN-BARTLE, Sodra Sandby (SE); Christer FÅHRAEUS, Bjarred (SE)

(73) Assignee: FlatFrog Laboraties AB, Lund (SE)

(21) Appl. No.: 14/652,757

(22) PCT Filed: Dec. 17, 2013
(86) PCT No.: PCT/SE2013/051533

§ 371 Date: Jun. 16, 2015

Related U.S. Application Data
(60) Provisional application No. 61/738,035, filed on Dec. 17, 2012.

(30) Foreign Application Priority Data
Dec. 17, 2012 (SE) 12514394

(51) Int. Cl. G06F 3/042; G02B 6/42

(52) U.S. Cl. CPC G06F 3/0421; G02B 6/4214; G06F 2203/04104; G06F 2203/04109; G06F 2203/04103

(57) ABSTRACT

A laminated optical element is provided for a touch-sensitive apparatus which operates by light frustration (FTIR), and comprises: a light-transmissive panel (1) that defines a front surface (5) and an opposite, rear surface (6); a light-coupling mechanism for light input to and output from the panel, arranged along a perimeter of a touch-sensitive region (4) of the optical element; a shielding element (70) applied at the front surface (5) over the light-coupling mechanism; and a light-transmissive sheet (60) disposed overlapping the shielding element and covering the front surface of the panel within the shielding element, wherein a lower surface of the light-transmissive sheet is in optical contact with the front surface of the panel, so as to allow light within a predetermined wavelength range to propagate between at least first and second positions of the light-coupling mechanism by total internal reflection in an upper surface of the light-transmissive sheet.

### CROSS-REFERENCE TO RELATED APPLICATIONS

The present application claims the benefit of Swedish patent application No. 1251439-4, filed 17 Dec. 2012, and U.S. provisional application No. 61/738,035, filed 17 Dec. 2012, both of which are incorporated herein by reference.

### TECHNICAL FIELD

The present invention relates to the field of touch-sensing systems that operate by propagating light by internal reflections along well-defined light paths inside a thin light-transmissive panel, and in particular to solutions for providing a robust and user friendly optical element for such a touch-sensing system.

### BACKGROUND ART

This type of touch-sensing system is known as an FTIR-based system (FTIR, Frustrated Total Internal Reflection). It may be implemented to operate by transmitting light inside a solid light-transmissive panel, which defines two parallel boundary surfaces connected by a peripheral edge surface. Light generated by a plurality of emitters is coupled into the panel so as to propagate by total internal reflection (TIR) between the boundary surfaces to a plurality of detectors. The light thereby defines propagation paths across the panel, between pairs of emitters and detectors. The emitters and detectors are arranged such that the propagation paths define a grid on the panel. An object that touches one of the boundary surfaces (“the touch surface”) will attenuate (“frustrate”) the light on one or more propagation paths and cause a change in the light received by one or more of the detectors. The location (coordinates), shape or area of the object may be determined by analyzing the received light at the detectors. This type of apparatus has an ability to detect plural objects in simultaneous contact with the touch surface, known as “multi-touch” in the art.

In one configuration, e.g. disclosed in US2006/0114237, the light is coupled into the panel directly through the peripheral edge surface. Such an approach allows the light to be simply and efficiently injected into the panel. Also, such an in-coupling does not add significantly to the thickness of the touch system. However, in-coupling via the edge surface requires the edge surface to be highly planar and free of defects. This may be difficult and/or costly to achieve, especially if the panel is thin and/or manufactured from a comparatively brittle material such as glass. In-coupling via the edge surface may also add to the footprint of the touch system. Furthermore, it may be difficult to optically access the edge surface if the panel is attached to a mounting structure, such as a frame or bracket, and it is also likely that the mounting structure causes strain in the edge surface.

U.S. Pat. No. 3,673,327 discloses an FTIR-based touch system in which the emitters and detectors are arranged in rows on opposite ends of the panel, and light beams are propagated between opposite pairs of emitters and detectors so as to define a rectangular grid of propagation paths. Large prisms are attached to the bottom surface of the panel to couple the light beams into and out of the panel.

In U.S. Pat. No. 7,432,893, a few large emitters are arranged at the corners of the panel, or centrally on each side of the panel, to inject diverging light beams (“fan beams”) into the panel for receipt by linear arrays of photodiodes along all sides of the panel. Each fan beam is coupled into the panel by a large revolved prism which is attached to the top surface of the panel, and the photodiodes are attached to the top or bottom surface of the panel, so as to define a plurality of propagation paths between each prism and a set of photodiodes.

By attaching prisms or wedges to the top or bottom surfaces, it is possible to relax the surface requirements of the edge surface and/or to facilitate assembly of the touch system. However, the prisms or wedges may add significant thickness and weight to the system. To reduce weight and cost, the wedge may be made of plastic material. On the other hand, the panel is often made of glass, e.g. to attain required bulk material properties (e.g. index of refraction, transmission, homogeneity, isotropy, durability, stability, etc.) and surface evenness of the top and bottom surfaces. The present applicant has found that the difference in thermal expansion between the plastic material and the glass may cause a bulky wedge to come loose from the panel as a result of temperature variations during operation of the touch system. Even a small or local detachment of the wedge may cause a significant decrease in the performance of the system.

In the field of LCD display technology, which is outside the field of touch-sensitive systems, it is known to couple light from LEDs into thin light-guide panels as part of so-called backlights (BLUs, Backlight units) for LCD displays. These light-guide panels are located behind the LCD and are configured to emit light across its top surface to uniformly illuminate the rear side of the LCD. Various strategies for coupling light into light-guides for the purpose of back-illuminating LCD displays are disclosed in the publication “Using micro-structures to couple light into thin light-guides”, by Yun Chen, Master of Science Thesis, Stockholm 2011, TRITA-ICT-EX-2011:112.

### SUMMARY

It is an objective of the invention to at least partly overcome one or more limitations of prior art FTIR-based touch systems.

More specifically, one objective is to provide an optical element for an FTIR-based touch-sensitive apparatus, which is robust and compact, while providing a convenient user interface.

In addition, it is an objective to provide an FTIR-based touch-sensitive apparatus, which in addition to such an optical element includes at least also an emitter and a detector.

These and other objectives that may appear from the description below are at least partly achieved by means of a laminated optical element for use in a touch-sensitive apparatus, and a touch-sensitive apparatus as such, configured according to the independent claims, embodiments thereof being defined by the dependent claims.

A first aspect of the invention relates to a laminated optical element for a touch-sensitive apparatus, comprising: a light-transmissive panel that defines a front surface and an opposite, rear surface; a light-coupling mechanism for light input to and output from the panel, arranged along a perimeter of a touch-sensitive region of the optical element; a shielding element applied at the front surface over the light-coupling mechanism; a light-transmissive sheet disposed overlapping the shielding element and covering the front surface of the panel within the shielding element, wherein a lower surface of the light-transmissive sheet is in optical contact with the front surface of the panel, so as to allow light within a predetermined wavelength range to propagate between at least first and second positions of the light-coupling mechanism by total internal reflection in an upper surface of the light-transmissive sheet.

In one embodiment, the shielding element is non-transmissive within said predetermined wavelength range.

In one embodiment, said predetermined wavelength range lies in the infrared region.

In one embodiment, the shielding element is non-transmissive to visible light.

In one embodiment, at least an area under the shielding element, facing the panel, is specularly reflective within the predetermined wavelength range.

In one embodiment, an optical bonding element is provided between the front surface of the panel and the lower surface of the light-transmissive sheet.

In one embodiment, the shielding element is formed on the lower surface of the light-transmissive sheet, and wherein an optical bonding element is provided between, on the one hand, the front surface of the panel and, on the other hand, the lower surface of the light-transmissive sheet and the shielding element.

In one embodiment, the light-transmissive sheet is a flexible film.

In one embodiment, the light-transmissive sheet is a flexible film, adapted to at least partly smooth out a height difference between an upper surface of the shielding element and the front surface of the panel.

In one embodiment, the light-transmissive sheet includes a rigid layer.

In one embodiment, at least a layer of the light-transmissive sheet is made from the same material as the light-transmissive panel.

In one embodiment, the light-coupling mechanism comprises at least one diffusively reflecting element arranged on the panel beneath the shielding element.

In one embodiment, said diffusively reflecting element is arranged on the front surface of the panel.

In another embodiment, said diffusively reflecting element is arranged on the rear surface of the panel.

One embodiment, in which at least one diffusively reflecting element is arranged on the panel beneath the shielding element, comprises an interface for optical connection to at least one of a light emitter and a light detector at the rear surface below the diffusively reflecting element, wherein said interface is configured to lead an input beam of light onto said diffusively reflecting element so as to generate propagating light, and to output received detection light generated as propagating light impinges on said diffusively reflecting element.

In one embodiment, in which at least one diffusively reflecting element is arranged on the panel beneath the shielding element, said at least one diffusively reflecting element comprises at least one elongate strip of diffusively reflecting material.

In one embodiment, in which at least one diffusively reflecting element is arranged on the panel beneath the shielding element, said at least one diffusively reflecting element has the shape of a sequence of spatially separated or partially overlapping dots of elliptic or circular shape arranged along the perimeter of the touch-sensitive region.

Another aspect of the invention relates to a touch-sensitive apparatus, comprising: a light-transmissive panel that defines a front surface and an opposite, rear surface; a plurality of light emitters for light input to, and a plurality of light detectors for output from, the panel via a light-coupling mechanism arranged along a perimeter of a touch-sensitive region of the apparatus, so as to define a grid of propagation paths across the touch-sensitive region between pairs of light emitters and light detectors; a shielding element, opaque to light within said predetermined wavelength range and visible light, applied at the front surface over the light-coupling mechanism; a light-transmissive sheet disposed overlapping the shielding element and covering the front surface there within, wherein a lower surface of the light-transmissive sheet is in optical contact with the front surface of the panel, so as to allow light within a predetermined wavelength range to propagate in said grid by total internal reflection in the upper surface of the light-transmissive sheet.

In one embodiment, the touch-sensitive apparatus further comprises: at least one diffusively reflecting element arranged on the panel beneath the shielding element and over said emitters and detectors, wherein said light emitters are configured to emit beams of light onto said diffusively reflecting element so as to generate propagating light, and wherein said light detectors are configured to receive detection light generated as propagating light impinges on said diffusively reflecting element.

Still other objectives, features, aspects and advantages of the present invention will appear from the following detailed description, from the attached claims as well as from the drawings.

### BRIEF DESCRIPTION OF DRAWINGS

Embodiments of the invention will now be described in more detail with reference to the accompanying schematic drawings.

FIG. 1A is a section view of a light-transmissive panel using FTIR for touch detection.

FIG. 1B is a top plan view of an FTIR-based touch-sensitive apparatus.

FIG. 2 is a 3D plot of an attenuation pattern generated based on energy signals from an FTIR-based touch-sensitive apparatus.

FIG. 3 is a section view of an example of a touch-sensitive apparatus.

FIGS. 4-5 illustrate section views of variants of diffusive in-coupling and out-coupling which are relevant to certain aspects embodiments of the invention.

FIGS. 6-9 respectively show section views of one side of embodiments of a laminated optical elements according to embodiments of the invention.

FIG. 10 is a top plan view of a laminated optical element for use in a touch-sensitive apparatus, according to certain embodiments.

FIGS. 11A-11B are enlarged views to illustrate characteristics of the embodiment in FIG. 10.

FIGS. 12A-12B are top plan views of a laminated optical element for use in a touch-sensitive apparatus, according to other embodiments.

### DETAILED DESCRIPTION OF EXAMPLE EMBODIMENTS

In the following, embodiments of the present invention will be presented for an example of a laminated optical element, as well as a touch-sensitive apparatus incorporating such a laminated optical element. Throughout the description, the same reference numerals are used to identify corresponding elements.

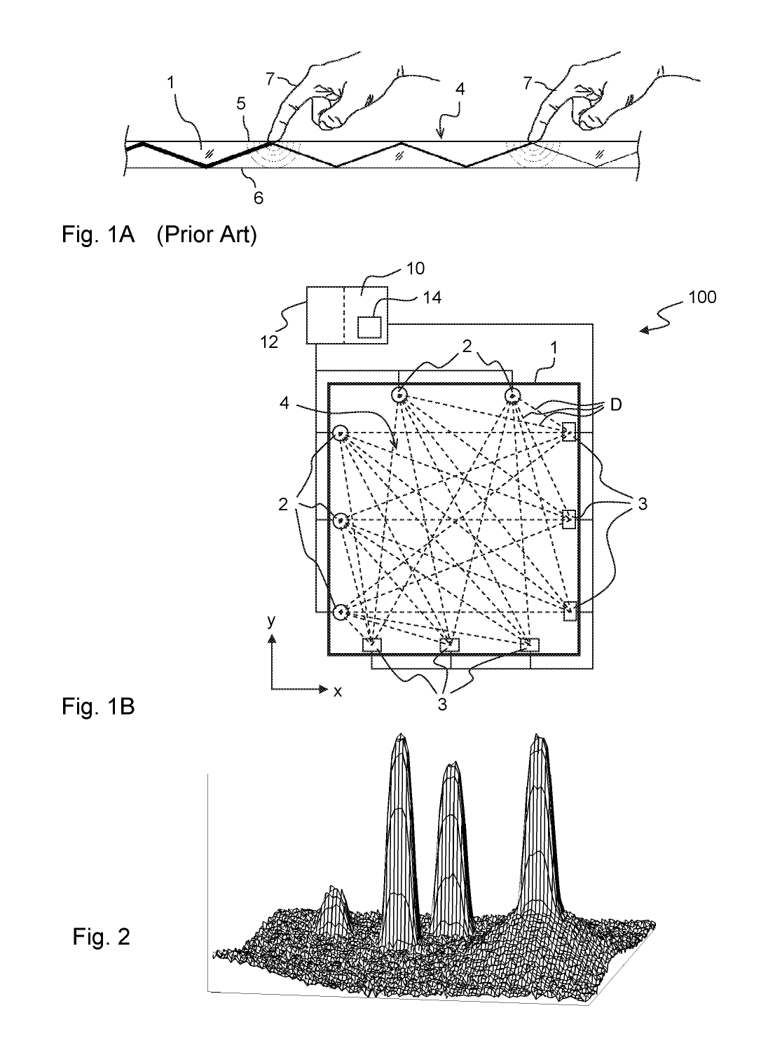

FIG. 1A illustrates the concept of touch detection based on attenuation by FTIR (Frustrated Total Internal Reflection) of propagating light. According to this concept, light is transmitted inside a panel 1 along a plurality of well-defined propagation paths. The panel 1 is made of a solid material in one or more layers and may have any shape. The panel 1 defines an internal radiation propagation channel, in which light propagates by internal reflections. In the example of FIG. 1A, the propagation channel is defined between the boundary surfaces 5, 6 of the panel 1, and the front (top) surface 5 allows the propagating light to interact with touching objects 7 and thereby defines a touch-sensitive region 4. The interaction is enabled by injecting the light into the panel 1 such that the light is reflected by total internal reflection (TIR) in the front surface 5 as it propagates through the panel 1. The light may be reflected by TIR in the rear (bottom) surface 6 or against a reflective coating thereon. It is also conceivable that the propagation channel is spaced from the rear surface 6, e.g. if the panel comprises multiple layers of different materials. The panel 1 may thus be made of any solid material (or combination of materials) that transmits a sufficient amount of light in the relevant wavelength range to permit a sensible measurement of transmitted energy. Such material includes glass, poly(methyl methacrylate) (PMMA) and polycarbonates (PC). The panel 1 may be designed to be overlaid on or integrated into a display device or monitor (not shown in FIG. 1A).

As shown in FIG. 1A, an object 7 that is brought into close vicinity of, or in contact with, the touch-sensitive region 4 may interact with the propagating light at the point of touch. In this interaction, part of the light may be scattered by the object 7, part of the light may be absorbed by the object 7, and part of the light may continue to propagate in its original direction across the panel 1. Thus, the touching object 7 causes a local frustration of the total internal reflection, which leads to a decrease in the energy (or equivalently, the power or intensity) of the transmitted light, as indicated by the thinned lines downstream of the touching objects 7 in FIG. 1A.

FIG. 1B illustrates an example embodiment of a touch-sensitive apparatus 100 that is based on the concept of FTIR. Emitters 2 (indicated by open circles throughout the description) are distributed along the perimeter of the touch-sensitive region 4, beneath the panel 1, to project light onto the panel 1 such that at least part of the light is captured inside the panel 1 for propagation by internal reflections in the propagation channel. Detectors 3 (indicated by open squares throughout the description) are distributed along the perimeter of the touch-sensitive region 4, beneath the panel 1, to receive part of the propagating light. The light from each emitter 2 will thereby propagate inside the panel 1 to a number of different detectors 3 on a plurality of light propagation paths D. Even if the light propagation paths D correspond to light that propagates by internal reflections inside the panel 1, the light propagation paths D may conceptually be represented as “detection lines” that extend across the touch-sensitive region 4 between pairs of emitters 2 and detectors 3, as shown in FIG. 1B. Thus, the detection lines correspond to a projection of the propagation paths D onto the touch-sensitive region 4. Thereby, the emitters 2 and detectors 3 collectively define a grid of detection lines D (“detection grid”) on the touch-sensitive region 4, as seen in a top plan view. The spacing of detection lines in the detection grid defines the spatial resolution of the apparatus 100, i.e. the smallest object than can be detected on the touch-sensitive region 4.

As used herein, the emitter 2 may be any type of device capable of emitting radiation in a desired wavelength range, for example a diode laser, a VCSEL (vertical-cavity surface-emitting laser), an LED (light-emitting diode), an incandescent lamp, a halogen lamp, etc. The emitter 2 may also be formed by the end of an optical fiber. The emitters 2 may generate light in any wavelength range. The following examples presume that the light is generated in the infrared (IR), i.e. at wavelengths above about 750 nm. Analogously, the detector 3 may be any device capable of converting light (in the same wavelength range) into an electrical signal, such as a photo-detector, a CCD device, a CMOS device, etc.

The detectors 3 collectively provide an output signal, which is received and sampled by a signal processor 10. The output signal contains a number of sub-signals, also denoted “projection signals”, each representing the energy of light received by a certain light detector 3 from a certain light emitter 2. Depending on implementation, the signal processor 10 may need to process the output signal for separation of the individual projection signals. The projection signals represent the received energy, intensity or power of light received by the detectors 3 on the individual detection lines D. Whenever an object touches a detection line, the received energy on this detection line is decreased or “attenuated”.

The signal processor 10 may be configured to process the projection signals so as to determine a property of the touching objects, such as a position (e.g. in the x,y coordinate system shown in FIG. 1B), a shape, or an area. This determination may involve a straight-forward triangulation based on the attenuated detection lines, e.g. as disclosed in U.S. Pat. No. 7,432,893 and WO2010/015408, or a more advanced processing to recreate a distribution of attenuation values (for simplicity, referred to as an “attenuation pattern”) across the touch surface 1, where each attenuation value represents a local degree of light attenuation. An example of such an attenuation pattern is given in the 3D plot of FIG. 2, where the peaks of increased attenuation represent touching objects. The attenuation pattern may be further processed by the signal processor 10 or by a separate device (not shown) for determination of a position, shape or area of touching objects. The attenuation pattern may be generated e.g. by any available algorithm for image reconstruction based on projection signal values, including tomographic reconstruction methods such as Filtered Back Projection, FFT-based algorithms, ART (Algebraic Reconstruction Technique), SART (Simultaneous Algebraic Reconstruction Technique), etc. Alternatively, the attenuation pattern may be generated by adapting one or more basis functions and/or by statistical methods such as Bayesian inversion. Examples of such reconstruction functions designed for use in touch determination are found in WO2009/077962, WO2011/049511, WO2011/139213, WO2012/050510, and WO2013/062471, all of which are incorporated herein by reference.

In the illustrated example, the apparatus 100 also includes a controller 12 which is connected to selectively control the activation of the emitters 2 and, possibly, the readout of data from the detectors 3. Depending on implementation, the emitters 2 and/or detectors 3 may be activated in sequence or concurrently, e.g. as disclosed in WO2010/064983. The signal processor 10 and the controller 12 may be configured as separate units, or they may be incorporated in a single unit. One or both of the signal processor 10 and the controller 12 may be at least partially implemented by software executed by a processing unit 14.

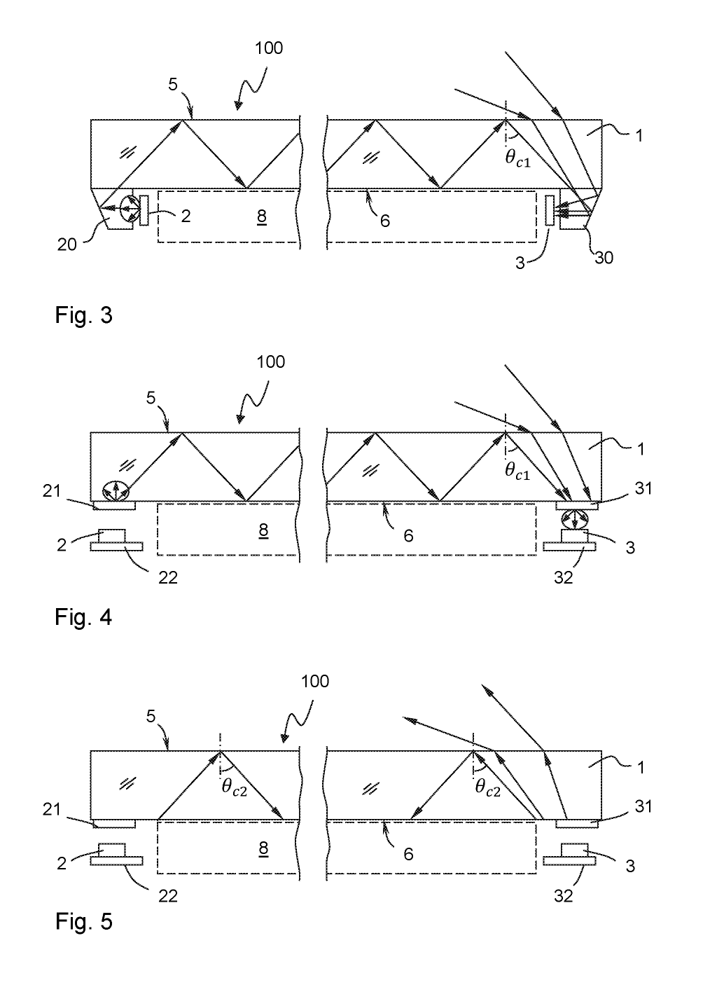

FIG. 3 is a section view of an example of an FTIR-based touch-sensitive apparatus 100, which makes use of a light-coupling mechanism comprising individual prism-type optical in-coupling elements 20 (one shown) of light-transmissive material. These in-coupling elements 20 are attached to the rear surface 6 of the panel 1 to achieve highly efficient specular coupling of a diverging beam of light from an individual emitter 2 into the panel 1. The light-coupling mechanism correspondingly comprises individual optical out-coupling elements 30 attached to the rear surface 6 to achieve highly efficient specular coupling of light out of the panel 1 onto an individual detector 3. A backside panel 8 may be provided under the touch-sensitive apparatus 100, such as a display device 8 having a display surface facing rear side 6 so as to be visible through the touch-sensitive apparatus. The touch-sensitive apparatus 100 typically has a width in two dimensions (e.g. horizontally in the drawing) that is substantially larger than its height (vertical in the drawing), and only the outer parts of the apparatus 100 are shown in the section view of the drawing for the sake of simplicity.

To achieve efficient coupling of light, the emitters 2 and detectors 3 may need to be precisely mounted in relation to the coupling elements 20, 30, which may be difficult to achieve in mass production. Also, the luminance profile of the light generated by the emitter 2 affects the resulting distribution of light within the panel 1, e.g. the distribution of light between the different detection lines. The use of prism-type coupling elements 20, 30 also adds weight and height to the apparatus 100. Furthermore, the use of individual coupling elements 20, 30 typically results in a width (cross-section) of the detection lines (as seen in a top plan view) which is narrow compared to the center-to-center spacing of adjacent coupling elements. This may lead to an incomplete coverage of the touch-sensitive region 4 by the detection lines. Depending on the arrangement of emitters 2 and detectors 3, the incomplete coverage may be pronounced at vertical or horizontal symmetry lines across the touch-sensitive region 4 and at the periphery of the touch-sensitive region 4 close to the coupling elements 20, 30. Incomplete coverage is likely to cause aliasing artifacts to occur in the reconstructed attenuation pattern, making touch determination more difficult. Furthermore, to reduce system cost, it may be desirable to minimize the number of electro-optical components 2, 3, but a reduced number of components tends to increase the spacing between detection lines and may thus enhance the reconstruction artifacts.

FIG. 4 discloses another example of a type of FTIR-based touch-sensitive apparatus 100, devised to alleviate at least some of the afore-mentioned shortcomings of the example of FIG. 3. The touch-sensitive apparatus 100 of FIG. 4 makes use of a different type of light-coupling mechanism to generate the detection lines, but is otherwise functionally similar, with the same reference numerals indicating like elements. Different embodiments of the in-coupling and out-coupling mechanism as indicated in FIG. 4 are described in detail in applicant's prior U.S. provisional application 61/675,032 and Swedish patent application SE1250890-9, both filed on Jul. 24, 2012, (equivalent to International patent application PCT/SE2013/050922, filed on Jul. 22, 2013) which are incorporated herein by reference. In the in-coupling embodiment shown in FIG. 4, each emitter 2 is arranged to optically face the panel 1, and the light-coupling element comprises a diffuser 21, attached to the rear surface 6 next to emitter 2 at the rim of the panel 1. The emitter 2 is supported on a PCB 22 designed to supply power to potentially control signals to the emitter 2. The diffuser 21 is configured as a non-imaging component that diffusely transmits a portion of the incoming light into the panel 1. As is well-known to the skilled person, a non-imaging, diffusively transmitting surface will, when illuminated, emit light over a large solid angle at each location on the surface, as indicated by encircled rays in the drawings. The diffuse transmission is governed by “scattering” (also known as a combination of “diffuse reflection” and “diffuse transmission”) which refers to reflection, refraction and interference (diffraction) of light at a surface as well as by particles dispersed in the bulk beneath the surface, such that an incident ray is scattered at many angles rather than being reflected at just one angle as in “specular reflection” or “specular transmission”. Thus, part of the incoming light from the emitter 2 (one ray shown in FIG. 4) will be scattered by the diffuser 21, and a portion of this light will be transmitted into the panel 1. As is well-known to the skilled person, a “non-imaging” optical component is, in contrast to an imaging optical component, not designed with respect to the phase of the incoming light e.g. for the purpose of forming an image of a light source in a focal plane or generating a highly collimated beam of light, but is instead designed to achieve a dedicated optical radiative transfer of light from a source onto a target regardless of the phase of the light.

Accordingly, when illuminated, the diffuser 21 will act as a light source which is located in contact with the propagation channel inside the panel 1 to emit diffuse light, so as to define the actual origin of the detection lines that are generated by the light from the respective emitter 2. Since the diffuser 21 more or less randomly re-distributes the incoming light, the importance of the luminance profile of the emitter 2 is reduced or even eliminated. This means that the diffuser 21 has the ability to act as a light source for many different types of emitters 2 and for many different relative orientations between the emitter 2 and the diffuser 21, as long as the light from the emitter 2 hits the diffuser 21 to a proper extent and at a proper location. Thus, compared to conventional coupling elements that operate by optical imaging, the sensitivity to manufacturing and mounting tolerances is reduced and assembly of the apparatus 100 is facilitated. This makes the apparatus 100 better suited for mass production. The diffuser 21 may be designed as a low cost component that adds little thickness and weight to the apparatus 100.

In one out-coupling embodiment of the light-coupling mechanism of FIG. 4, each detector 3 is arranged to optically face the panel 1, and a diffuser 31 is attached to the rear surface 6 next to detector 3 at the rim of the panel 1. The diffuser 31 diffusely transmits a portion of the incoming propagating light, whereby at least part of the diffusively transmitted light reaches the detector 3. Accordingly, each diffuser 31 will act as a light source that diffusively emits “detection light” for receipt by the detector 3, thereby defining the direction of the detection lines from the emitters 2 across a touch-sensitive region 4. The diffuser 31 in FIG. 4 may be configured in the same way as the diffuser 21, to attain corresponding advantages. In the illustrated embodiment, the detector 3 is attached to a PCB 32 which is designed to supply power to and transmit measurement data from the detector 3. PCB 32 may be the same as PCB 22, arranged flat alongside the rear surface 6. Each diffuser 21, 31 may be provided as a thin, sheet-like element on the rear surface 6. Such a sheet-like diffuser may be so thin and flexible that it is able to absorb shear forces that may occur in the interface between the diffuser and the panel 1, e.g. caused by differences in thermal expansion as discussed in the background section. The diffuser 21, 31 may e.g. be a coating, layer or film applied to the rear surface 6. In certain embodiments the diffusers 21 and 31 may be printed as small patches using offset print, tamper print, jet print (using uv-curing lacquers) or may be directly embossed onto the rear surface 6. The diffusers 21 and 31 may be provided as separate elements, or as one coherent strip, as will be further described below with reference to FIGS. 10 to 12. Since the diffuser 21 is arranged at the rear surface 6, it is possible to keep the front surface 5 free of additional layers and components. This is known as “flush” or “edge-to-edge”, which is desirable from a user point-of-view in the field of touch systems, as will be further described below.

Fingerprints and other impurities on the front surface 5 will diffusively scatter ambient light into the panel 1, some of which may progress by TIR to the detector 3. However, not only light that enters through diffusive scattering may reach the detector 3, but also light entering the panel 1 by refraction close to the detector 3. In FIGS. 3 and 4, Total Internal Reflection (TIR) in the panel 1 is represented by a set of arrows from emitter 2 to detector 3, and θ_{c1} represents the critical angle for internal reflection as given by Snell's law. To the right in FIGS. 3 and 4, two arrows are drawn to represent incident light from above, e.g. sunlight or other ambient light. Dependent on the specific configuration of the light-coupling mechanism, such incident light may reach the detector 3. This type of incident light may add to the noise level of the system, and may cause saturation problems at the detector side.

Furthermore, another problem associated with the touch-sensitive apparatus 100 is highlighted in FIG. 5. As illustrated by the outbound arrows representing visible light, indicated to the right in FIG. 5, the light-coupling mechanism 31 on the detector side will be visible through the front surface 5. Correspondingly, the light-coupling mechanism 21 on the emitter side will also be visible, and supporting structures such as PCB 22, 32 may also be visible around a display 8 through the front surface 5. These visible structures may clutter the appearance of the touch-sensitive apparatus 100 and may cause information shown by a display 8 close to its perimeter to be difficult to distinguish. Unwanted visible light that may pass out from front surface 5 is that which originates from outside the perimeter of an interface area for the underlying display 8, that will not be caught in TIR. The innermost point of incidence of unwanted light on the front surface 5 from within the panel 1 is indicated in the drawing by the dash-dotted lines where TIR occurs at critical angle θ_{c2}, for at least a part of the visible region. As is well known to the skilled person, the refractive indices for materials which are transmissive to visible light is normally slightly lower in the IR region than in the visible region. For this reason, θ_{c2} may be different from θ_{c1}, and normally slightly smaller.

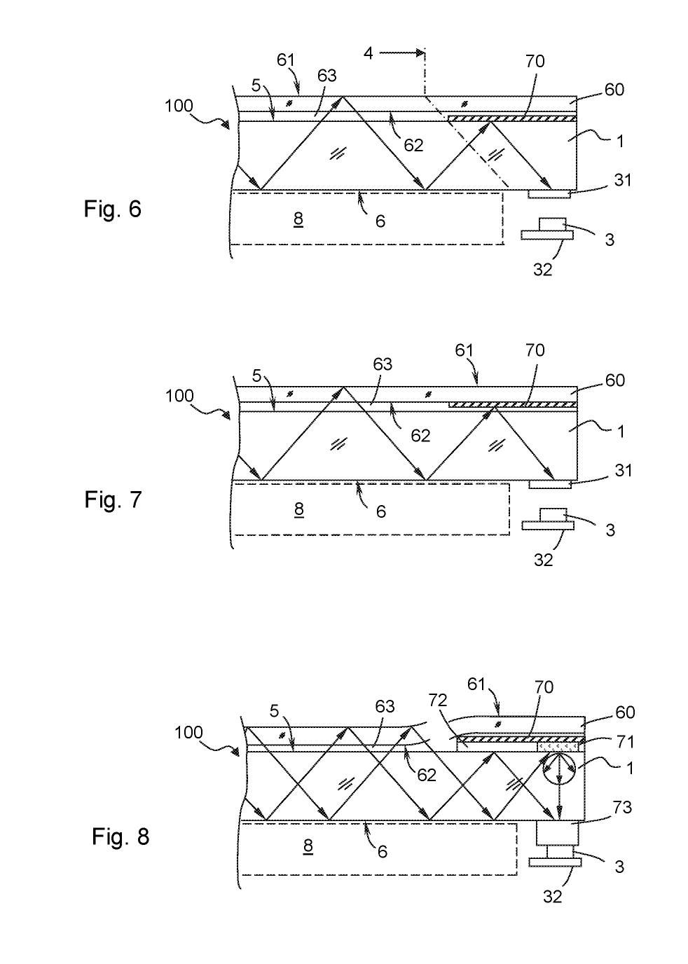

FIGS. 6-9 show different embodiments of the invention, aiming at overcoming both the problem of direct incident ambient light on the detectors 3, and the visibility of the emitters 2, detectors 3, and the light-coupling mechanisms, as well as any visibly reflecting structures such as PCB, display bezel, display gaskets, mounting structures etc, while still providing a substantially flush, edge-to edge, front surface. Each of these figures show a section view of only one side of a touch-sensitive apparatus 100 including the laminated optical element, in which a light-coupling mechanism for a detector 3 is shown, for the sake of simplicity. The shielding element extends all the way around the touch-sensitive region 4, though, and thus also over the light-coupling mechanism for the emitters 2 in a corresponding manner.

FIG. 6 shows an embodiment in which a shielding element 70 is provided on the front surface 5 of the panel 1 in alignment with the light-coupling mechanism 31 for the detector 3. As outlined above, the light-coupling mechanism 31 may include a diffuser, but may in addition, or alternatively, include a refractive element for controlling output of light from the panel 1 to the detector 3. The light-coupling mechanism may include diffusers 21, 31 configured without refracting structures, implemented as a film of diffusing particles in a simple, robust and cost effective manner. The film may be applied to the rear surface 6 by painting, spraying, lamination, gluing, etc. Any inherently translucent material may be used for forming the film, e.g. a matte white paint or ink. However, the paint may be optimized to obtain a desired diffusive transmission ratio, e.g. by including pigments with low refractive index or spherical objects of different materials. One such pigment is SiO₂, which has a refractive index n=1.6. There are many dedicated materials that are commercially available, e.g. the fluoropolymer Spectralon, barium-sulphate-based paints or solutions, granular PTFE, microporous polyester, Makrofol® polycarbonate films provided by the company Bayer AG, etc.

In another embodiment, the diffusers 21, 31 comprise refracting structures on the side facing away from the rear surface 6. In such a diffuser design, also known as an engineered diffuser, the refracting structures may be implemented as an arrangement (typically random or pseudo-random) of microstructures tailored to generate a desired diffuse transmission. Examples of engineered diffusers include holographic diffusers, such as so-called LSD films provided by the company Luminit LLC. In a variant, the engineered diffuser is tailored to promote diffuse transmission into certain directions in the surrounding hemisphere, in particular to angles that sustain TIR propagation inside the panel 1. The engineered diffuser may, in addition to the refractive structures, include diffusing particles. The engineered diffuser may be provided as a separate flat or sheet-like device which is attached to the rear surface 6 e.g. by adhesive. Alternatively, the diffuser 21, 31 may be provided in the rear surface 6 by etching, embossing, molding, abrasive blasting, etc.

The shielding element 70 is configured to visibly hide the area outside an intended interface to a display 8 provided under the panel 1, e.g. the light-coupling mechanism 31, the detector 3 and its support structure 32. To this end, the element 70 may be non-transmissive (opaque) to visible light. Furthermore, the shielding element 70 is designed to block ambient light in a predetermined wavelength range of intended use by emitters 2 and detectors 3. In one embodiment, this predetermined wavelength range lies in the IR region. In a preferred embodiment, the wavelength range will lie between 750 nm and 1000 nm, for which both transmissive materials as well as emitters 2 and detectors 3 are readily available.

The shielding element 70 may be implemented as a coating or film, in one or more layers, on the front surface 5. For example, an inner layer facing the front surface 5 may provide the specular and possibly partly-diffuse reflectivity, and an outer layer may block ambient and/or visible light. In one embodiment, the shielding element 70 may comprise a chromium layer provided onto the top surface 5, to obtain a surface towards the panel 1 which is at least partially specularly reflective to light in the predetermined wavelength range. In addition, the shielding element 70 may comprise an outer layer, which is substantially black to block visible light, by oxidizing the upper surface of the chromium layer. In other embodiments, other metals, with corresponding oxides, may be used, such as aluminum, silver etc. In yet other embodiments, the specularly reflecting lower layer may be provided by means of a metal, whereas an upper layer may be provided by means of paint, e.g. black paint. In any case, as indicated in the drawings, shielding element 70 is preferably substantially flat, and should be as thin as possible while providing the desired benefits of blocking IR light and visible light. The height of the shielding element 70 and of the light-transmissive sheet 60 will add to the thickness of the overall device, and also decrease the touch-sensitive region 4 by mechanical vignetting at the inner edge of the shielding element 70. This is indicated in FIG. 6 by dash-dotted lines, showing an angled line representing the outermost path for a light beam reflected at the upper surface 61 at the steepest possible angle, i.e. the critical angle. The vertical line thus schematically illustrates the right-most border of the touch-sensitive region 4. In order not to clutter the drawings, this border of the touch-sensitive region is 4 not shown in FIG. 7-9.

Shielding element 70 may be reflective on the side facing the panel 1. This may be particularly beneficial if a diffuser 31 is employed. Light that is transmitted by diffuser 31 at an angle smaller than the above-mentioned critical angle (and therefore will not propagate by TIR in the panel 1) is then reflected back into the panel 1. This light is denoted “leakage light” in the following. The element 70 may thereby serve to increase the efficiency of the in-coupling, by recycling a portion of the leakage light. In one implementation, the reflective element 70 is configured for primarily specular reflection. Thereby, leakage light on the emitter side (not shown) may be reflected back towards the diffuser 21, which may diffusively reflect a portion of leakage light into angles that sustain propagation by TIR. In another implementation, the reflective element 70 is instead configured for diffuse reflection, or for absorption of the leakage light.

Providing the panel 1 with the shielding element 70 alone would at least alleviate the mentioned optical issues of ambient light input and visibility of the light-coupling mechanism. However, it would also introduce an edge at the perimeter of the touch-sensitive region 4. In some embodiments, the shielding element 70 may be formed as a single layer provided on the surface 5 of the panel 1, as in FIG. 6, with a very low profile. The height of shielding element 70 may be less than 10 μm, or even in the range of 1-5 μm. For such a very thin element, it may be impossible to visibly notice the edge. However, touch-sensitive apparatuses are frequently used not only for pointing input, but also for swiping gestures. Particularly, many graphical user interface operated by touch input involve gestures starting from within the touch-sensitive region 4 and ending at the perimeter of or outside the touch sensitive region 4, to indicate scrolling, sending, flipping, page turning or other functions. When making a gesture with an object 7, particularly when using the tip of your finger, the edge of the slightly higher shielding element 70 may indeed be felt. A result thereof may be a negative effect on the user experience, due to the discomfort of swiping your fingers over an edge. Another problem may be that grease and dirt may stick to the front surface 5 at the edge of the shielding element 70, which may both increase the leakage of ambient light into the panel 1, and negatively influence the touch sensitivity at the perimeter. Also, repetitive swiping of objects 7 over the edge of shielding element 70 may wear the shielding element, and thus gradually deteriorate its shielding effect.

In order to overcome these problems with a front-facing shielding element 70, the present invention suggests to sandwich the shielding element 70 between the panel 1 and a light-transmissive sheet 60. In the embodiment of FIG. 6 the light-transmissive sheet 60 is attached with a lower surface 62 facing the front surface 5 of the panel 1 and the shielding element 70. An opposing upper surface 61 forms the surface in which frustration under FTIR occurs upon touch. In one embodiment, the light-transmissive sheet 60 may be connected to the panel 1 by means of an optical bonding element 63. Such a bonding element 63 may be a film which is sandwiched between the panel 1 and the light-transmissive sheet 60 to act as an adhesive. Examples of such films are Optically Clear Adhesive (OCA) and Contrast Enhancement Film (CEF), both provided by 3M™, which are usable for both flexible-to-rigid and rigid-to-rigid lamination. In other embodiments, the bonding element 63 may be provided in liquid form which is subsequently cured, in either a wet bonding process or a dry bonding process, both of which are well known in the art of lamination. In one embodiment, silicon may be used as a bonding element 63.

The optical bonding element 63 and the light-transmissive sheet 60 are preferably both in optical contact with the panel 1, so as to promote light from within the panel 1 to propagate through the optical bonding element 63 and into the light-transmissive sheet 60, and after TIR in the upper surface 61 to propagate back into the panel 1. In one embodiment, optical matching is obtained by selecting materials such that the refractive indices of the light-transmissive sheet 60 and the panel 1 are close, or even the same, and also the refractive index for optical bonding element 63 should be as close as possible for the predetermined wavelength. In another embodiment, where materials of different refractive indices are selected for the panel 1 and the light-transmissive sheet 60, an optical bonding material 63 may be selected which has a refractive index lying between the refractive indices of the panel 1 and the light-transmissive sheet 60. As an alternative embodiment, the light-transmissive sheet 60 is bonded directly to the front surface 5 without an intermediate adhering layer 63 (not shown). The light-transmissive sheet 60 may be successively built on the front surface 5, and over shielding element 70, by chemical vapor deposition according to well-known processes. As another alternative, the light-transmissive sheet 60 may be applied in liquid form, e.g. by spraying, condensation, rolling, or even spin-coating. The sheet 60 may then subsequently be cured into solid state by a method suitable for the material used, such as by heating, cooling, or radiation.

The thickness of the panel 1 is normally dependent on its size, i.e. the length and width of the panel 1. Also, the properties of the material chosen for the panel 1, and for the light-transmissive sheet 60, will affect how thin the touch-sensitive apparatus may be. For touch-sensitive apparatuses in the range of 10 inch diagonally, the panel 1 may be less than 500 μm thick, and for smaller apparatuses even thinner panels 1 are plausible. For large size panels 1 the panel 1 may be several mm thick. In one embodiment, where the panel 1 is in the range of 500-1000 μm thick, the light-transmissive sheet 60 is preferably substantially thinner, e.g. in the range of 10-500 μm. In a preferred embodiment, the panel 1 is made of a rigid material, e.g. glass or other material as outlined with reference to FIG. 1A, and acts as a carrier for the entire sandwiched laminated optical element. In one embodiment, the light-transmissive sheet 60 is a film made of or comprising a layer of PET (poly(ethylene terephthalate)).

FIG. 7 illustrates an alternative embodiment, which in most aspects is similar to the embodiment of FIG. 6. The illustrated difference is that, while the shielding element 70 is supported on the panel 1 in FIG. 6, the embodiment of FIG. 7 shows a solution where the shielding element is instead provided on the lower surface 62 of the light-transmissive sheet 60. While both these embodiments will fulfill the object of blocking both visible and IR light, they have different additional benefits compared to each other.

The area of the light-transmissive sheet 60 provided over the shielding element 70 may be used for other purposes. Examples of such purposes may be capacitive soft keys, logotypes or decorative ornaments, formed in or over the shielding element 70 under the lower surface 62. In such embodiments, it may be desirable to have the shielding element 70 formed directly on the light-transmissive sheet 60. That way the process of applying the optical bonding element 63 may be less critical, since imperfect adherence under the shielding element 70 will not be visible. It may also be more cost efficient, and allow a greater freedom to modification, to provide the shielding element 70 on the light-transmissive sheet 60, from a production point of view, than to apply the shielding element 70 to the panel 1, which may be made of a more brittle material, such as glass.

On the other hand, applying the shielding element 70 on the front surface 5 of the panel 1, as in FIG. 6, may provide the benefit of a very controlled interface between the detectors 3 and the surface of the shielding element facing the detectors 3. For embodiments where the light-coupling mechanism places high requirements on alignment of the detectors 3, or emitters 2, and either the shielding element 70 or any structure provided under the shielding element 70 at the front surface 5, the embodiment of FIG. 6 may be beneficial from a production point of view. Also, the configuration of FIG. 6 means that the shielding element 70 will be provided closer to the upper surface 61 than in the configuration of FIG. 7, which means that the size of the touch-sensitive region 4 may be larger. However, this is an effect that will only be of importance if the thickness of the optical bonding element is comparatively thick, with respect to the thickness of the light-transmissive sheet 60, as can be understood from the dash-dotted lines in FIG. 6.

In any case, by means of the laminated optical element shown in the embodiments of FIG. 6 or 7, the entire top surface 61, including both the touch-sensitive region 4 and the area provided over the shielding element, is substantially flush without edges, and thereby highly suitable for touch input.

FIG. 8 illustrates an embodiment in which structures having more than purely light-blocking purposes are provided under the shielding element 70. The disclosed embodiment is based on the applicant's earlier U.S. provisional application 61/662,581, and Swedish patent application SE1250665-5, both filed on Jun. 21, 2012, (equivalent to International patent application PCT/SE2013/050735, filed on Jun. 19, 2013) both of which are hereby incorporated by reference. In this embodiment, the light-coupling mechanism comprises a diffuser 71 attached to the front surface 5 opposite to emitter 2 at the rim of the panel 1. In addition, a diffuser 71 is provided opposite to a detector 3, but as for the embodiments of FIGS. 6 and 7 only the detector side shown in FIG. 8. The diffusers placed over the emitter 2 and over the detector 3, respectively, may be different elements, or a single common element formed along the perimeter of the touch-sensitive region 4. Where separate elements are used for the diffuser over the emitter 2 and the diffuser over the detector 3, these may be made of different materials. However, in a preferred embodiment, the diffuser 71 over the emitter 2 and the diffuser over the detector 3 are of the same type. Nevertheless, the same reference numeral 71 will be used for both the diffuser over the emitter 2 and the diffuser over the detector 3, be they separate or integral.

On the incoming side (not shown), diffuser 71 scatters the light from the emitter 2 into the panel 1 by diffuse reflection. So, where the embodiments of FIGS. 6 and 7 may benefit from scattering through diffuse transmission in a diffuser 31, the embodiment of FIG. 8 relies on diffuse reflection in a diffuser 71. Accordingly, the diffuser 71 will act as a light source which is located in contact with the propagation channel inside the panel 1 to emit diffuse light, thereby defining the actual origin of the detection lines that are generated by the light from the respective emitter 2. Since the diffuser 71 more or less randomly re-distributes the incoming light, the importance of the luminance profile of the emitter 2 is reduced or even eliminated. This means that the diffuser 71 has the ability to act as a light source for many different types of emitters 2 and for many different relative orientations between the emitter 2 and the diffuser 71, as long as the light from the emitter 2 hits the diffuser 71 with a proper extent and at a proper location. An optional light input coupling element 73 may be comprised also in the embodiment of FIG. 8 for index matching purposes.

On the out-coupling side of the light-coupling mechanism, shown in FIG. 8, each detector 3 is arranged to optically face the panel 1, and a diffuser 71 is attached to the top surface 5 opposite to detector 3 at the rim of the panel 1. The diffuser 71 scatters the incoming propagating light by diffuse reflection, whereby at least part of the diffusively scattered light reaches the detector 3. Accordingly, each diffuser 71 will act as a light source that diffusively emits “detection light” for receipt by the detector 3, so as to define the direction of the detection lines from the emitters 2 across the touch-sensitive region 4. In the illustrated embodiment, the detector 3 is attached to a PCB 32 which is designed to supply power to and transmit measurement data from the detector 3. The use of the diffuser 71 allows the detector 3 to optically face the panel 1 and the PCB 32 to be arranged flat alongside the bottom surface 6. Furthermore, the same PCB 32 may also be employed to carry the emitter 2 (not shown).

For both the emitter side and the detector side, the diffuser 71 may be configured as an essentially ideal diffuse reflector, also known as a Lambertian diffuser, which generates equal luminance from all directions in a hemisphere surrounding the diffuser 71. Many inherently diffusing materials form a near-Lambertian diffuser. In an alternative, the diffuser 71 may be a so-called engineered diffuser, e.g. a holographic diffuser. The engineered diffuser may also be configured as a Lambertian diffuser. In a variant, the engineered diffuser is tailored to promote diffuse reflection into certain directions in the surrounding hemisphere, in particular to angles that are capable of sustaining total internal reflection in the radiation propagation channel inside the panel 1. There are also inherently diffusing materials that promote diffuse reflection into certain directions and that may be arranged on the panel 1 to form the diffuser 71.

Many materials exhibit a combination of diffuse and specular reflection. In the set up of FIG. 8, any light that is specularly reflected by the diffuser 71 will leave the panel 1 through the bottom surface 6 and result in coupling losses. It is thus preferred that the relation between diffusive and specular reflection is high for the diffuser 71. It is currently believed that reasonable performance may be achieved, at least for smaller touch surfaces, when at least 50% of the reflected light is diffusively reflected. Preferably, the diffuser 71 is designed to reflect incoming light such that at least about 60%, 70%, 80%, 90%, 95%, or 99% of the reflected light is diffusively reflected.

The diffuser 71 may be implemented as a coating, layer or film applied to the top surface 5. In one embodiment, the diffuser 71 is implemented as matte white paint or ink applied to the top surface 5. In order to achieve a high diffuse reflectivity, it may be preferable for the paint/ink to contain pigments with high refractive index. One such pigment is TiO₂, which has a refractive index n=2.8. It may also be desirable, e.g. to reduce Fresnel losses, for the refractive index of the paint filler and/or the paint vehicle to match the refractive index of the surface material in the top surface. The properties of the paint may be further improved by use of specially tailored pigments such as e.g. EVOQUE™ Pre-Composite Polymer Technology provided by the Dow Chemical Company.

There are many other coating materials for use as a diffuser that are commercially available, e.g. the fluoropolymer Spectralon, polyurethane enamel, barium-sulphate-based paints or solutions, granular PTFE, microporous polyester, GORE® Diffuse Reflector Product, etc. Alternatively, the diffuser 71 may be implemented as a flat or sheet-like device, e.g. the above-mentioned engineered diffuser or white paper, which is attached to the top surface 5 by an adhesive. According to other alternatives, the diffuser 71 may be implemented as a semi-randomized (non-periodic) micro-structure in or on the top surface 5 with an overlying coating of reflective material. The micro-structure may e.g. be provided by etching, embossing, molding, abrasive blasting, etc. In another alternative, the diffuser 71 may be light-transmissive (e.g. a light-transmissive diffusing material or a light-transmissive engineered diffuser) and covered with a coating of reflective material.

Also in the embodiment of FIG. 8, a shielding element 70 is provided over the diffuser 71. As outlined with respect to the embodiments shown in FIGS. 6 and 7, the shielding element 70 provides the benefit of preventing visible access to the light-coupling mechanism, including the diffuser 71 and the emitters 2 and detectors 3 at the rear side 6 of the panel 1, as well as any visibly reflecting structures such as PCB, display bezel, display gaskets, mounting structures etc. Also, the shielding element 70 functions to prevent incident ambient IR light from reaching both the detector 3 and the diffuser 71. Furthermore, characteristics for both the shielding element 70 and the light-transmissive sheet 60 described with reference to FIGS. 6 and 7 are equally applicable to the embodiment of FIG. 8. Consequently, the shielding element 70 may be provided on the front surface 5 of the panel 1, over the diffuser 71, as illustrated in FIG. 8 and corresponding to the embodiment of FIG. 6. Alternatively, the shielding element 70 may be provided on the downwards-facing lower side 62 of the light-transmissive sheet 60, corresponding to the embodiment of FIG. 7 (not shown).

The application of a diffuser 71 will add extra height to the perimeter region around the touch-sensitive region 4, compared to the embodiments of FIGS. 6 and 7. Dependent on how the diffuser 71 is realized, its height will differ. For a diffuser 71 comprising a spot of white paint, its thickness may be between 10 and 50 μm. On the inner side of diffuser 70, i.e. adjacent the touch-sensitive region 4, and potentially also on the outer side of the diffuser, a reflecting element 72 may be provided. This reflecting element may have the benefit increasing the specular reflection within the panel 1, since the lower surface of diffuser 71 may be elevated from the front surface 5. As an example, reflecting element 72 may comprise a metallic coating, or silver paint. Furthermore, the reflecting element 72 may provide the function of evening out the area around the diffuser 71, such that the shielding element 70 has a substantially even elevation over the front surface 5. A benefit thereof may be a smoother upper surface 61 of the light-transmissive sheet 60 over the diffuser 71.

Dependent on the elevation of the shielding element 70 as compared to the front surface 5 of the panel 1, in combination with the thickness and material properties of the light-transmissive sheet 60, the light-transmissive sheet 60 may partly flex to adapt to the height difference. Such a situation is schematically illustrated in FIG. 8. In one embodiment, the elevation of the upper surface of the shielding element 70 is in the order of 10-60 μm over the front surface 5, or even up to 100 μm. Without any light-transmissive sheet 60 the edge of that elevation may be both visibly detectable, due to shadowing effects, and be the cause of reduced function, for the reasons set out above. However, with a smooth transition over that edge, as provided by means of the flexing light-transmissive sheet 60 in FIG. 8, the actual elevation may be substantially or completely undetectable by a touching object 7. Furthermore, as the sharpness of the edge is covered by the light-transmissive sheet 60, the risk of wear to the edge, and potential reduction of touch sensitivity close to the shielding element 70, is minimized or even eliminated. The effect will therefore be that the laminated optical element may be perceived as flush.

It should be noted, though, that an optical bonding element 63 applied between the light-transmissive sheet 60 and the front surface 5, as described with respect to FIGS. 6 and 7, may partly or completely even out the elevation of the shielding element 70, such that no flexing of the light-transmissive sheet 60 occurs. As an alternative to an optical bonding element layer to even out the thickness, a first transmissive film layer 63 may be provided within the shielding element 70, and with substantially the same height. The light-transmissive sheet 60 is then subsequently applied as a second layer. These layers may e.g. be formed according to any of the methods described with reference to the light-transmissive sheet 60 in FIGS. 6 and 7.

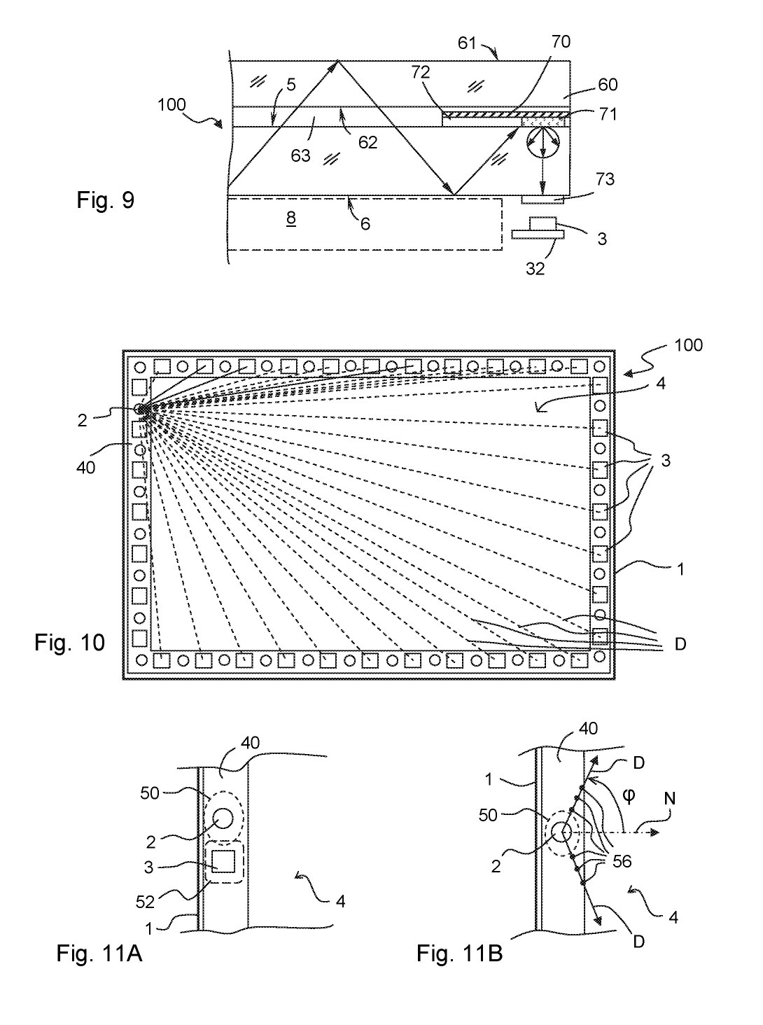

FIG. 9 shows a variant of the embodiment of FIG. 8, where the difference lies in the light-transmissive sheet 60. In this embodiment the light-transmissive sheet 60 is substantially rigid. This way, the height elevation of the shielding element 70 at the perimeter will not cause any substantial deflection of the light-transmissive sheet 60. An optical bonding element 63 is provided between the front surface 5 and the light-transmissive sheet 60, as explained with reference to FIG. 6 above.

The light-transmissive sheet 60 of FIG. 9 may be formed of a single, substantially rigid element. Alternatively, the light-transmissive sheet 60 may comprise several layers, of which at least one is substantially rigid. Preferably the rigid light-transmissive sheet 60 in the embodiment of FIG. 9 is made of the same material as the panel 1, e.g. glass, PMMA or polycarbonate. That way, thermal expansion characteristics will be the same in these two elements, which may lead to high environmental endurance. The thickness of the rigid light-transmissive sheet 60 may be dependent on the material. In certain embodiments, the thickness of the light-transmissive sheet 60 may be in the range 10-20% of the total laminated optical element 100.

For any one of the embodiments of FIGS. 6-9, it is to be understood that the apparatus 100 may implement the diffusive coupling technique only for in-coupling (or out-coupling), while employing conventional coupling techniques for out-coupling (or in-coupling), e.g. by dedicated coupling elements as shown in FIG. 3 or coupling via the edge surface as discussed in the background section. However, additional technical advantages are achieved by implementing the diffusive coupling technique for both in-coupling and out-coupling (denoted “combined diffusive coupling” in the following). For one, the assembly of the apparatus 100 may be further facilitated and more suitable for mass production. Eliminating dedicated optical coupling elements may yield reductions in terms of cost, weight and height.

In one embodiment with combined diffusive coupling, the diffusers 21 or 71 for the emitters 2 and the diffusers 31 or 71 for the detectors are implemented by a coherent band or strip 40 of diffusively transmitting material that extends along a portion outside the perimeter of the touch-sensitive region 4, and the emitters 2 and detectors 3 are arranged beneath the panel 1 along the extent of the strip 40. One example of this embodiment is shown in FIG. 10, in which the emitters 2 and detectors 3 are alternated around the entire perimeter of the touch-sensitive region 4 and the strip 40 forms a frame around the touch-sensitive region 4. For the purpose of illustration, the emitters 2 and detectors 3 are made visible through the strip 40. FIG. 10 also schematically indicates the detection lines D that are defined between one emitter 2 on one side of the touch-sensitive region 4 and the detectors 3 on the other sides of the touch-sensitive region 4. It may be noted that in FIG. 10, as well as in FIGS. 11A and B, the shielding element 70 is left out.

FIG. 11A is an enlarged view of the panel in FIG. 10 and shows one emitter 2 and one detector 3 beneath the strip 40. The dashed line 50 indicates a central part of the region of the strip 40 that is illuminated by the emitter 2, e.g. where the intensity has decreased to 50%, and thus defines a region of origin for the light that is propagated along the associated detection lines (not shown). The dashed line 52 similarly indicates the projection of the field of view of the detector 3 onto the strip 40 and thus defines a region of origin for the light that is received by the detector 3 on associated detection lines (not shown). It should be noted that the respective regions 50 and 52 are schematic, with respect to shape and size. However, it may be realized that the detection lines associated with the adjacent emitter 2 and detector 3 in FIG. 11A may be brought to partly overlap by controlling the overlap of the projection regions 50, 52 on the strip 40. The cross-section of detection lines created in this way is broad with long tails, with overlap between the detection lines from neighboring components 2, 3. Thus, by broadening the detection lines, the coverage of the touch-sensitive region 4 may be improved. The broadening of the detection lines effectively corresponds to a low pass filtering of the projection signals, which may enable a reduction of reconstruction artifacts such as aliasing artifacts.

The coherent strip 40 also has the advantage of reducing the mounting tolerances of the components 2, 3 in relation to the panel 1, since detection lines will be defined as long as the projection regions 50, 52 fall within the strip 40.

One potential drawback of the coherent strip 40 in FIG. 10 is that detection lines D that extend at large angles φ to the normal N of the strip 40 (in the plane of the panel 1) may exhibit a poor transfer efficiency if the propagating light hits the strip 40 outside of the respective projection region 50, 52. Each hit will result in a diffusive transmission of light and thus a loss of propagating light in that projection direction. This phenomenon is further illustrated in FIG. 11B, where the light that originates from a projection region 50 of an emitter 2 and propagates by internal reflections along two detection lines D hits the strip 40 at three locations 56 outside the projection region 50. The impact of this “self-scattering phenomenon” may be reduced by setting the width of the strip 40 essentially equal to the bounce spacing at the critical angle. However, the self-scattering may still affect the detection lines D that extend close to the edges of the touch-sensitive region 4 (cf. FIG. 10), potentially resulting in poor performance in these regions.

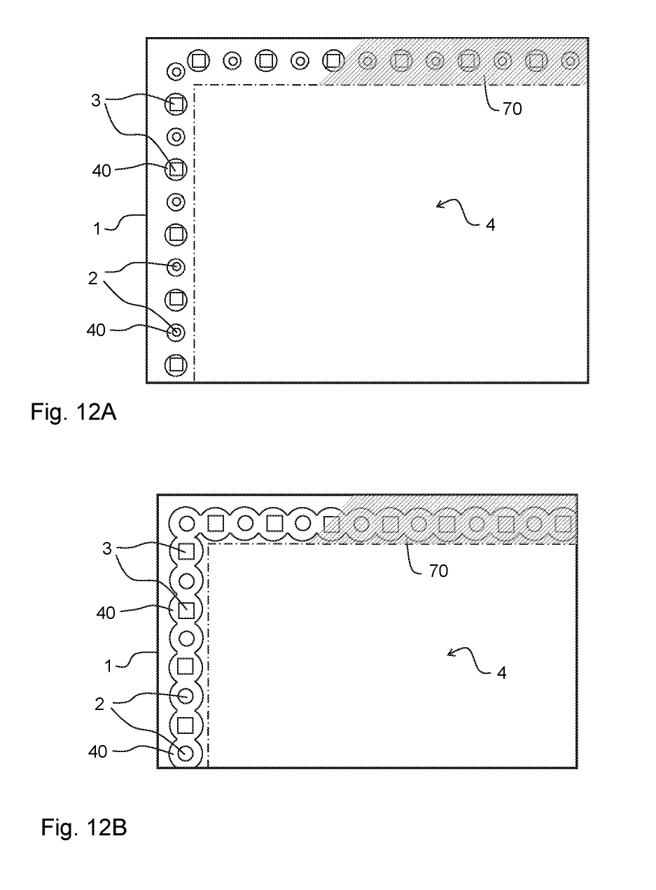

The self-scattering may be overcome by another embodiment with combined diffusive coupling, in which the diffusers 40 are configured as dots 21, 31 of diffusively transmitting material formed on the rear surface 6 in a principal functional model in accordance with FIG. 6 or 7, or alternatively as dots 71 of diffusively reflecting material formed on the front surface 5 in a principal functional model of FIG. 8 or 9. For the sake of simplicity, when referring to FIGS. 12A and 12B, these dots will still be referred to by the reference numeral 40 for both the emitter diffusers and the detector diffusers. It may be preferable for the dots 40 to be elliptic, e.g. approximately circular, although other shapes are conceivable, e.g. polygons. FIG. 12A is a top view of a corner portion of an apparatus 100 that implements this embodiment. For the purpose of illustration, the emitters 2 and detectors 3 are made visible beneath the dots 40, which thus are located directly above a respective emitter/detector. It is realized that the use of confined and spatially separated dots 40 will reduce the impact of self-scattering on the detection lines D that extend along the edges of the touch-sensitive region 4. In FIG. 12A, also a portion of the shielding element 70 is shown by means of a dashed structure. As explained above, the shielding element 70 visibly covers the light-coupling mechanism, i.e. at least the dots 40, and also the underlying emitters 2 and detectors 3. The dashed structure of the shielding element 70 is therefore only schematic, whereas it would in practice be opaque to visible light, as well as IR light in the range of use by the emitters 2 and detectors 3.

In this specific example, the dots 40 above the detectors 3 are larger than the dots 40 above the emitters 2, which reflects the difference between irradiance distribution and detector sensitivity, as well as differences in chip sizes; the detector 3 is typically larger than the emitter 2. Other configurations are possible. Generally, the distribution and size of the dots 40 may be optimized with respect to maximizing the coverage of the touch-sensitive region 4 by the detection lines while minimizing the impact of self-scattering.

FIG. 12B illustrates a variant in which adjacent dots 40 are arranged to partially overlap while still reducing the amount of self-scattering. This variant may be seen as a hybrid of the strip in FIG. 10 and the separated dots in FIG. 12A, since the overlapping dots 40 effectively form a coherent strip with an undulating border towards the touch-sensitive region 4 for reduction of self-scattering.

To optimize coupling efficiency, the projection regions 50, 52 may be matched to the extent of the respective dot 40. However, too small dots 40 may introduce undesirably strict tolerance requirements, e.g. with respect to the performance of individual components 2, 3 and the placement of the components 2, 3. Furthermore, the distance between the panel 1 and the components 2, 3 may change slightly when the surface of the touch-sensitive region 4 is being touched, unless the components 2, 3 are mechanically secured towards the panel 1, causing variations in the size of the projections regions 50, 52 and thus variations in the projection signals. It may therefore be desirable to ensure that, nominally, the projection regions 50 (the beam spot) of the emitters 2 are smaller than and are included within the respective dot 40, and the projection regions 52 of the detectors 3 are larger than and include the respective dot 40.

Also the embodiment of FIG. 12B includes an opaque shielding element 70, a portion of which is shown by means of a dashed structure. Correspondingly, the shielding element 70 visibly covers the light-coupling mechanism, i.e. at least the connected dots 40, and also the underlying emitters 2 and detectors 3, and it is also opaque to IR light in the range of use by the emitters 2 and detectors 3.

The use of the diffuser 21, 31, 71, 40 enables a compact design of the apparatus 100. As shown in the drawings, the emitter 2 may be arranged on a connecting substrate 22 such as a PCB (Printed Circuit Board) which is designed to supply power and transmit control signals to the emitter 2. In the drawings, the emitter 2 is a top emitting component, horizontally mounted on the PCB 22 and configured to emit divergent or diffuse light through its top surface towards the diffuser 21, 71, and thereby the PCB 22 may be arranged flat along the rear surface 6. Correspondingly, the detector 3 is a top detecting component, horizontally mounted on the PCB 32 and configured to detect light at its top surface from the diffuser 31,71, and also the PCB 32 may be arranged flat along the rear surface 6. However it is to be understood that this particular arrangement of the emitters 2 and detectors 3 is only an example, and that the emitters 2 and detectors 3 may be mounted to, or be inherently configured to, emit and receive, respectively, divergent, collimated or diffuse light at a non-perpendicular angle to the diffusers 21, 31, 71. Furthermore, the added combination of the shielding element 70, sandwiched in a laminated optical element between the main panel 1 and the upper light-transmissive element 60, provides a very low profile optical element for an FTIR touch-sensitive apparatus 100, with an edge-to-edge flush front surface 61.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

For example, the specific arrangement of emitters and detectors as illustrated and discussed in the foregoing, as well as the specific examples of the light-coupling mechanism for input and output of light, are merely given as examples. Also, additional transmissive layers may be provided over the upper surface 61, such as an anti-fingerprint coating. The inventive coupling structure is useful in any touch-sensing system that operates by transmitting light, generated by a number of emitters, inside a light-transmissive panel and detecting, at a number of detectors, the decrease in propagating light caused by the frustration at the point of touch.

1. A laminated optical element for a touch-sensitive apparatus, comprising:
a light-transmissive panel that defines a front surface and an opposite, rear surface;
a light-coupling mechanism for light input to and output from the panel, arranged along a perimeter of a touch-sensitive region of the optical element;
a shielding element applied at the front surface over the light-coupling mechanism;
a light-transmissive sheet disposed overlapping the shielding element and covering the front surface of the panel within the shielding element,
wherein a lower surface of the light-transmissive sheet is in optical contact with the front surface of the panel, so as to allow light within a predetermined wavelength range to propagate between at least first and second positions of the light-coupling mechanism by total internal reflection in an upper surface of the light-transmissive sheet.

2. The laminated optical element of claim 1, wherein the shielding element is non-transmissive within said predetermined wavelength range.

3. The laminated optical element of claim 1, said predetermined wavelength range lies in the infrared region.

4. The laminated optical element of claim 1, wherein the shielding element is non-transmissive to visible light.

5. The laminated optical element of claim 1, wherein at least an area under the shielding element, facing the panel, is specularly reflective within the predetermined wavelength range.

6. The laminated optical element of claim 1, wherein an optical bonding element is provided between the front surface of the panel and the lower surface of the light-transmissive sheet.

7. The laminated optical element of claim 6, wherein the shielding element is formed on the lower surface of the light-transmissive sheet, and wherein the optical bonding element is provided between, on the one hand, the front surface of the panel and, on the other hand, the lower surface of the light-transmissive sheet and the shielding element.

8. The laminated optical element of claim 1, wherein the light-transmissive sheet is a flexible film.

9. The laminated optical element of claim 8, wherein the light-transmissive sheet is adapted to at least partly smooth out a height difference between an upper surface of the shielding element and the front surface of the panel.

10. The laminated optical element of claim 1, wherein the light-transmissive sheet includes a rigid layer.

11. The laminated optical element of claim 10, wherein at least said rigid layer of the light-transmissive sheet is made from the same material as the light-transmissive panel.

12. The laminated optical element of claim 1, wherein the light-coupling mechanism comprises
at least one diffusively reflecting element arranged on the panel beneath the shielding element.

13. The laminated optical element of claim 12, wherein said diffusively reflecting element is arranged on the front surface of the panel.

14. The laminated optical element of claim 12, wherein said diffusively reflecting element is arranged on the rear surface of the panel.

15. The laminated optical element of claim 12, comprising
an interface for optical connection to at least one of a light emitter and a light detector at the rear surface below the diffusively reflecting element, wherein said interface is configured to lead an input beam of light onto said diffusively reflecting element so as to generate propagating light, and to output received detection light generated as propagating light impinges on said diffusively reflecting element.

16. The laminated optical element of claim 12, wherein said at least one diffusively reflecting element comprises at least one elongate strip of diffusively reflecting material.

17. The laminated optical element of claim 12, wherein said at least one diffusively reflecting element has the shape of a sequence of spatially separated or partially overlapping dots of elliptic or circular shape arranged along the perimeter of the touch-sensitive region.

18. A touch-sensitive apparatus, comprising:
a light-transmissive panel that defines a front surface and an opposite, rear surface;
a plurality of light emitters for light input to, and a plurality of light detectors for output from, the panel via a light-coupling mechanism arranged along a perimeter of a touch-sensitive region of the apparatus, so as to define a grid of propagation paths across the touch-sensitive region between pairs of light emitters and light detectors;
a shielding element, opaque to light within said predetermined wavelength range and visible light, applied at the front surface over the light-coupling mechanism;
a light-transmissive sheet disposed overlapping the shielding element and covering the front surface there within,
wherein a lower surface of the light-transmissive sheet is in optical contact with the front surface of the panel, so as to allow light within a predetermined wavelength range to propagate in said grid by total internal reflection in the upper surface of the light-transmissive sheet.

19. The touch-sensitive apparatus of claim 18, further comprising:
at least one diffusively reflecting element arranged on the panel beneath the shielding element and over said emitters and detectors,
wherein said light emitters are configured to emit beams of light onto said diffusively reflecting element so as to generate propagating light, and
wherein said light detectors are configured to receive detection light generated as propagating light impinges on said diffusively reflecting element.
